(19) United States
(12) Patent Application Publication
(10) Pub. No.: US 2021/0348853 A1
(43) Pub. Date: Nov. 11, 2021

(54) METHOD FOR PRODUCING CROCKERY FILLED WITH PHASE-CHANGE MATERIAL

(71) Applicant: PROMECO NV, Kortrijk (BE)

(72) Inventor: Karim REDJAL, Zwevegem (BE)

(73) Assignee: PROMECO NV, Kortrijk (BE)

(21) Appl. No.: 17/282,698

(22) PCT Filed: Oct. 4, 2019
(86) PCT No.: PCT/IB2019/058479

§ 371 Date: Apr. 2, 2021

(30) Foreign Application Priority Data
Oct. 5, 2018 (BE) 2018/5684

(51) Int. Cl. F28D 20/00; B29C 39/02; B29C 39/38; B29C 65/48; A47G 19/12

(52) U.S. Cl. CPC F28D 20/0034; B29C 39/02; B29K 2905/02; B29C 65/4845; A47G 19/127; B29C 39/38

(57) ABSTRACT

Method for producing crockery (460) filled with phase-change material, comprising the steps of pouring (110) liquid phase-change material into a mould, curing (120) of the phase-change material in the mould, packaging (130) the cured phase-change material in a package (330), drawing (140) a vacuum in the package filled with cured phase-change material, arranging (150) the package (330) filled with phase-change material against a wall (310) of a first part (510) of the crockery to be heated or cooled, arranging (160) a second part (520) of the crockery against the first part (510) of the crockery, such that the package (330) filled with phase-change material is enclosed by the first part and the second part of the crockery, and sealing (170) the first and second parts of the crockery arranged on each other, with sealing agent (570).

### FIELD OF THE INVENTION

The present invention relates to a method for producing double-walled crockery with a wall to be heated or cooled, and in particular to double-walled crockery provided with a phase-change material.

### BACKGROUND

The use of phase-change material as heat storage material in crockery, wherein the phase-change material is able to absorb heat in a relatively short time and to relinquish this heat again over a longer period of time, is known. An example of such an application is the use of phase-change material in a plate on which hot food is served. By making use of phase-change material the plate will cool less quickly and the food will remain warm for longer. A cavity filled with phase-change material is typically provided in the plate.

In the context of products which are used for serving food, these products must comply with determined consumer quality requirements, standards and/or guidelines. These requisites are an expression of the measurable demands and/or requirements which a product must meet. Known methods for producing double-walled crockery have the drawback that the produced products do not meet the consumer quality requirements, standards and/or guidelines. In the context of crockery with phase-change material these requirements are, among others: durability in the case of prolonged and/or frequent heating or cooling and/or after several washing cycles, food safety, preventing the release of phase-change material if the crockery breaks and/or cracks, or a combination of the foregoing.

### SUMMARY OF THE INVENTION

Embodiments of the invention have the object of producing crockery filled with phase-change material which meets the above stated requirements. It is a further object of the invention to provide a method for producing crockery with increased safety of use and extended utility and, consequently, improved durability. It is a further object of the invention to provide a method for producing crockery with an improved heat or cold transfer to the food.

According to a first aspect of the invention, a method is provided for producing crockery filled with phase-change material, comprising the steps of: pouring liquid phase-change material into a mould, curing of the phase-change material in the mould, packaging the cured phase-change material in a package, drawing a vacuum in the package filled with cured phase-change material, arranging the package filled with phase-change material against a wall of a first part of the crockery to be heated or cooled, and arranging a second part of the crockery against the first part of the crockery, such that the package filled with phase-change material is enclosed by the first part and the second part of the crockery, and sealing the first and second parts of the crockery, arranged on each other, with sealing agent.

Pouring liquid phase-change material into a mould enables any phase-change material to be formed in simple manner Crockery typically has specific shapes, by forming the liquid phase-change material it can already be achieved in a starting phase that a contact surface between the phase-change material and a wall of the crockery to be heated or cooled is maximized. This has the advantage that the heat transfer between the crockery and the served goods is improved. Both hot and cold liquid phase-change materials can further be used. The advantage of pouring liquid phase-change material into a mould is that undesired effects (shrinkage of phase-change material due to melting) of the use of solid phase-change material and the difficulty of shaping a granular material are prevented. The method further has the advantage that liquid phase-change material is viscous, whereby the phase-change material can be manipulated in simple manner.

By curing of the phase-change material in the mould the desired shape is preserved during the further production process. The advantage of curing of the phase-change material is that the cured phase-change material can be manipulated and processed in simpler manner in further production steps. In a further step the cured phase-change material can be vacuum-packed in efficient manner and a higher vacuum can be achieved when compared to the use of liquid phase-change material. By packaging the cured phase-change material in a package the method provides the advantage that crockery filled with phase-change material will not leak if the crockery breaks and/or tears and/or cracks. The packaging further also provides the advantage that the freedom of movement of the phase-change material in the package is limited. The phase-change material in the package is moreover shielded from possible contaminants during the production process and during use, and the cured phase-change material is protected against possible degradation of the phase-change material.

Drawing a vacuum in the package filled with solidified or cured phase-change material creates a high vacuum which prevents thermally insulating air from being present between the phase-change material and the walls of the package, or between different parts of the phase-change material. A high vacuum is defined as being a pressure between 1×10⁻¹ and 1×10⁻⁷ pascal. An improved heat transfer through the package and between the package and the served food is obtained by the drawing of the vacuum. The high vacuum in the package further prevents degradation of the phase-change material, since the chance of oxidative degradation is minimized Durable crockery can hereby be produced. In respect of safety, the drawing of the vacuum in the package also provides advantages, since the chance of dangerous mixtures of for instance alkanes and oxygen is minimized.

Because the package filled with phase-change material is arranged against a wall of a first part of the crockery to be heated or cooled, a better exchange of heat is obtained between the phase-change material and the wall to be heated or cooled when compared to known applications of phase-change material in crockery wherein a thermally insulating layer, for instance an air layer, is present between the phase-change material and the first wall to be heated or cooled. By arranging a second part of the crockery against the first part of the crockery, such that the package filled with phase-change material is enclosed by the first part and second part of the crockery, leakage paths are prevented or reduced in number when compared to known applications. The contact and the exchange of heat between the package filled with phase-change material and the wall to be heated or cooled is improved further in that the vacuum in the package ensures that the package encloses the phase-change material tightly. This prevents bending of the phase-change material and provides for good contact and a good exchange of heat.

Sealing the first and second parts of the crockery, arranged on each other, with sealing agent has the advantage that no exchange of matter is possible between an environment outside the crockery and the enclosed inner space of the crockery. Substantially no phase-change material, moisture or dust can hereby pass from the crockery, through the seal, to the surrounding area and/or vice versa.

In a preferred embodiment the method comprises of making the phase-change material liquid by means of melting, and curing of the phase-change material in the mould comprises of curing of the phase-change material on a cooling plate. Making the phase-change material liquid by means of melting enables the phase-change material to be formed in efficient manner, and the method provides the advantage that a hot phase-change material, for instance a phase-change material which is in a substantially solid phase at room temperature, can be processed in efficient manner. The phase-change material preferably has a melting temperature which is adapted to the application of the crockery. Phase-change material with such a melting temperature is highly suitable for application in crockery intended for hot foods and/or hot drinks. Typical phase-change materials which are used are alkanes (or mixtures of alkane), paraffins (or mixtures of paraffins), salt hydrates, propylene glycol-water mixtures with thickeners, fatty acids, alcohols, esters, mixtures of fatty acids, alcohols, esters and/or paraffins and/or eutectic materials. The solidifying or curing of the phase-change material in the mould on a cooling plate gives the phase-change material a desired shape and keeps the shape easily manipulable.

In a preferred embodiment the mould is a separate mould which can be placed on the cooling plate and removed from the cooling plate. Providing separate moulds which can be placed on the cooling plate enables different types of crockery to be processed. It is further also an advantage that the cured phase-change material can be removed from the mould and from the cooling plate more easily.

In a preferred embodiment the method comprises of removing the cured phase-change material from the mould. It will thus be possible to further process the cured phase-change material.

In a preferred embodiment the phase-change material is liquid at room temperature, the mould has a bottom and an upright side wall, and the curing of the phase-change material in the mould comprises of cooling of the phase-change material. Because the phase-change material is liquid at room temperature, the method provides the advantage that a cold phase-change material, for instance a phase-change material which is in a substantially liquid phase at room temperature, can be processed in efficient manner. It will be apparent to the skilled person that the phase-change material has a melting temperature which is adapted to the application of the crockery. The phase-change material preferably has a melting temperature of between 0° C. and 14° C., more preferably between 4° and 8° C. For other applications the phase-change material has a melting point of between −20° C. and 0° C. Phase-change material with such a melting temperature is highly suitable for application in crockery intended for serving cold foods such as ice cream dishes or for cold drinks. Because the curing of the phase-change material in the mould comprises of cooling of the phase-change material, the drawing of a vacuum in the package is simplified in a subsequent step of the method.

In a preferred embodiment the height of the upright side wall is a minimum of 5 mm, preferably a minimum of 10 mm, more preferably a minimum of 20 mm. It has been found that cold phase-change materials have the feature that the phase-change material creeps upward against the side wall during curing of the phase-change material. Providing the side wall with a minimum height prevents the phase-change material from creeping out of the mould. It will be apparent to the skilled person that the height can also be greater than 20 mm.

In a preferred embodiment the mould is an aluminium mould. It has been found that the material properties of the mould also affect said characteristic of upward creep of the phase-change material. The use of an aluminium mould has the advantage that the phase-change material crystallizes in controlled manner during the curing of the phase-change material. It has been found that aluminium moulds, relative to for instance stainless steel moulds, have the advantage that aluminium moulds have a smoother surface. The smoother surface prevents the phase-change material from creeping upward against the wall by displacing and adhering itself via scratches or the like.

In a preferred embodiment the mould is provided with a teflon coating and/or the mould is provided with a layer of silicone spray and/or paraffin, for instance tetradecane.

In a preferred embodiment cooling of the phase-change material comprises of cooling to at least 0° C., preferably to at least −12° C., most preferably to at least −19° C. It will be apparent to the skilled person that the cooling can also take place to temperatures below −19° C. It has been found that the phase-change material does not cure sufficiently at higher temperatures.

In a preferred embodiment cooling of the phase-change material comprises of cooling in a freezer or cooling by means of liquid nitrogen. By cooling by means of liquid nitrogen a low temperature is reached rapidly.

In a preferred embodiment the method comprises before the step of solidifying or curing of the phase-change material in the mould at least one of the following steps of:
adding an antioxidant to the liquid phase-change material;
adding a gelling agent to the liquid phase-change material;
adding a thickening agent to the liquid phase-change material; and
adding a phase-change material with a higher melting point in liquid state to the liquid phase-change material.

In this way the phase-change material can on the one hand be further protected against oxidative degradation, and leaking out of the phase-change material is further prevented on the other. Adding gelling agent or thickening agent increases the rheology and viscosity and internal consistency of the phase-change material, whereby the phase-change material will be able to escape less quickly or will be unable to escape if the package tears or leaks. By adding a phase-change material with a higher melting point in liquid state to the liquid phase-change material a form-retaining phase-change material can be obtained after solidifying or curing without any of the phase-change material remaining in liquid state, and in a further step the phase-change material can be vacuum-packed in efficient manner and a higher vacuum can be achieved when compared to the use of liquid phase-change material.

In a preferred embodiment the method comprises before the step of solidifying or curing of the phase-change material in the mould at least one of the following steps of:
absorbing the liquid phase-change material in an organic sorbent;
absorbing the liquid phase-change material in an inorganic sorbent; and
absorbing the liquid phase-change material in a plastic matrix.

In this way a form-retaining phase-change material is obtained and in a further step the phase-change material in solid form as solidified phase-change material, or as phase-change material absorbed in an (in)organic sorbent or in a plastic matrix, can be vacuum-packed in efficient manner, and a higher vacuum can be achieved when compared to the use of liquid phase-change material.

Structuring material is preferably added to the phase-change material during a step of the method so that a form-retaining mixture is obtained. The resulting mixture preferably comprises of about 90 to 95 percent phase-change material and 5 to 10 percent structuring agent.

Examples of such materials are activated carbon, (expanded) graphite, silica, and so on.

In a preferred embodiment the packaging of the cured phase-change material in a package comprises of:
placing cured phase-change material on a central part of a first film;
placing a second film on the cured phase-change material; and
mutually attaching the first film and the second film at corresponding peripheral parts of the two films, such that the cured phase-change material is enclosed by the package formed by the first and second film.

Films have the advantage that they can be laminated in advantageous manner, whereby different material properties can be combined in one film. Depending on the intended use of the package filled with phase-change material, it may be useful for the material properties of the first film to differ from the material properties of the second film. It may thus be advantageous for instance to provide the film of the package not intended for placing against the wall to be heated or cooled, and which is therefore remote from the wall to be heated or cooled, with an additional thermally insulating layer. Packaging of the phase-change material limits the freedom of movement of the phase-change material, whereby phase-change material is prevented from escaping if the crockery tears, cracks or breaks. The packaging also prevents the phase-change material from moving freely through the crockery when the crockery is moved or displaced. This enhances the stability and/or the ease of handling of the crockery.

In an embodiment the packaging of the phase-change material in solid form in a package comprises, before the step of placing the cured phase-change material on a central part of a first film, of preforming the first film, preferably in thermal manner. In this way a suitable space for the phase-change material can be provided.

In a further preferred embodiment the method further comprises of heating the second film before placing the second film on the cured phase-change material. Heating the second film makes the film more flexible and easier to form.

In a preferred embodiment the method further comprises of deforming the package filled with phase-change material by means of at least one formed pressure plate. The package filled with phase-change material here takes on the shape of the formed pressure plate. It will be apparent to the skilled person that different shapes are possible for different types of crockery.

In a further preferred embodiment the package filled with phase-change material is deformed between two formed pressure plates.

In a further preferred embodiment the at least one formed pressure plate corresponds to the wall of the first part of the crockery to be heated or cooled against which the package filled with phase-change material is to be arranged. Because the pressure plate corresponds to the wall to be heated or cooled, the package filled with phase-change material takes on this shape, and the method has the advantage that the package filled with phase-change material fits properly in the limited space between the wall of the first part and the second part of the crockery to be heated or cooled.

In a preferred embodiment the arranging of the package filled with phase-change material against the wall of a first part of the crockery to be heated or cooled comprises of fixedly adhering the package filled with phase-change material against the wall of a first part of the crockery to be heated or cooled. When the package filled with phase-change material is placed against the wall of the first part to be heated or cooled, it is advantageous that the film of the package interferes as little as possible with the absorption and release of heat by the phase-change material, and so facilitates the exchange of heat as well as possible. The film can therefore be provided from an aluminium or aluminium oxide layer, or another layer with microwave susceptor function.

In a further preferred embodiment the adhering is done with heat-resistant adhesive. The adhering with a heat-resistant adhesive has the advantage that the durability of the produced crockery is improved.

In a further preferred embodiment the adhering comprises of fixedly adhering at least a central part of the package to at least a central part of the wall to be heated or cooled. In phase transitions, i.e. when the phase-change material passes from liquid into solid or vice versa, the phase-change material will typically shrink or expand. This can be compensated for by fixedly adhering at least a central part of the package to at least a central part of the wall to be heated or cooled. The package hereby has at an edge part thereof sufficient freedom of movement when the phase-change material expands or shrinks. Food is moreover typically placed substantially at the central part of the wall to be cooled or heated, and the presence of phase-change material at the central part is particularly advantageous. It will be apparent to the skilled person that the expansion of the package depends on the expansion coefficient of the phase-change material used. By fixedly adhering at least a central part of the package crockery with an improved heat transfer is produced.

In a further preferred embodiment at least an edge part of the packaging is not adhered to the wall to be heated or cooled. At least an edge part is hereby freely movable when the phase-change material expands.

In a preferred embodiment the arranging of the second part comprises of positioning the second part in a recess provided for this purpose in the first part, and of fixedly adhering the second part at an edge thereof to an edge part of the recess. In this way the arranging and the lining up/aligning of the second part in the first part is realized in simple manner. This avoids placing errors, which ultimately improves the durability of the crockery. Because placing errors are avoided, the second part is properly aligned with the first part, whereby the recess between the first and the second part is substantially uniform, for instance a circle with a substantially uniform thickness. It is hereby made possible to obtain a seal in a further step.

In a further preferred embodiment the adhering of the second part at the edge thereof to an edge part of the recess comprises of applying adhesive to the edge part of the recess and pressing the second part thereagainst. The method hereby provides an efficient method for fixedly adhering the first and the second part.

In a preferred embodiment the sealing comprises of determining the sealing agent on the basis of at least one of colour, material, shape and a finishing layer of the crockery. It has been found that, depending on the above stated parameters, the use of a determined sealing agent can be advantageous. A determined sealing agent can thus be highly suitable for a first type of crockery, while being unsuitable for a second type of crockery. By determining the sealing agent on the basis of the above stated parameters an improved seal is obtained, this improving the durability of the crockery. Determining of the sealing agent can further take place on the basis of the air humidity and/or temperature in the environment in which the sealing takes place. Alternatively, the air humidity and/or temperature in the environment in which the sealing takes place can be controlled on the basis of the determined sealing agent and/or type of crockery.

In a preferred embodiment the sealing comprises of determining a sealing speed. The sealing of the first part to the second part is typically a chemical reaction of the sealing agent. A drawback of known seals is that they form bubbles in the seal during the curing, for instance air bubbles, acetic acid bubbles or bubbles of other occluded gases, which create a leakage path or wherein microorganisms can grow. It has been found for determined sealing agents that with a sufficiently low sealing speed the formation of bubbles is reduced or prevented, and that the quality of the seal is thereby improved. The sealing speed and the formation of bubbles can further be influenced by controlling air humidity and/or temperature in the environment in which the sealing takes place.

In a preferred embodiment the sealing agent comprises silicones. Silicones are characterized by their chemical resistance and thermal resistance. The use of silicones enables the seal to be arranged in efficient and durable manner.

In a preferred embodiment the sealing agent comprises silanes. It has been found that silanes bring about a better adhesion and better flexibility of the sealing agent and herein are less likely to tear loose and become torn and/or have less bubble formation.

In a preferred embodiment the sealing agent comprises a silicone-carbon mixture. The silicone-carbon mixture has the advantage that the formation of bubbles is reduced or prevented. A further advantage is that the bubbles which may have formed remain enclosed in the sealing agent and do not burst open.

In a preferred embodiment the method comprises of curing of the adhesive and/or sealing agent used. Curing of the adhesive and/or sealing agent used provides for an improved rigidity of the crockery.

In a preferred embodiment the curing of the adhesive and/or sealing agent used is performed by means of UV radiation. An advantage of the curing of adhesive or sealing agent by means of UV radiation is that short curing times are obtained, which prevent the formation of air bubbles. Rapid further processing of the crockery is further possible, and an improved chemical resistance and scratch resistance is obtained, this improving the durability of the crockery.

In a preferred embodiment the curing of the adhesive and/or sealing agent used is performed by means of heating. Heating the adhesive and/or sealing agent used provides the method with an efficient way of curing the adhesive or the sealing agent. By heating the adhesive and/or sealing agent before application thereof it can further be prevented that the adhesive and/or the sealing agent cools too rapidly, which would have an adverse effect on the adhesion of the adhesive and/or the sealing agent.

### BRIEF DESCRIPTION OF THE FIGURES

The above stated and other advantageous properties and objectives of the invention will become more apparent, and the invention better understood, on the basis of the following detailed description when read in combination with the accompanying drawings, in which:

FIG. 1 shows a schematic overview of an embodiment of a method for manufacturing a pouch, filled with phase-change material, according to the invention;

FIG. 2 shows a schematic overview of an embodiment of a method for packaging the cured phase-change material in a package;

FIG. 3A shows a simplified cross-section of an exemplary embodiment of a piece of crockery, wherein the phase-change material is arranged on a wall of a piece of crockery to be heated or cooled;

FIG. 3B shows a top view of an exemplary embodiment of a piece of crockery, wherein the phase-change material is arranged on a wall of a piece of crockery to be heated or cooled;

FIG. 4A shows a cross-section of an embodiment of a device for deforming phase-change material;

FIG. 4B shows a cross-section of an alternative embodiment of a device for deforming phase-change material;

FIG. 4B shows a cross-section of an alternative embodiment of a device for deforming phase-change material;

FIG. 4C shows a cross-section of an alternative embodiment of a device for deforming phase-change material;

FIG. 4D shows a cross-section of an alternative embodiment of a device for deforming phase-change material;

FIG. 4E shows a cross-section of an alternative embodiment of a device for deforming phase-change material;

FIG. 4F shows a cross-section of an alternative embodiment of a device for deforming phase-change material;

FIG. 4G shows a method of an alternative embodiment for deforming phase-change material;

FIG. 5A shows a cross-section of an embodiment of a piece of crockery with a first and a second part of the crockery arranged on each other;

FIG. 5B shows a cross-section of an alternative embodiment of a piece of crockery with a first and a second part of the crockery arranged on each other;

FIG. 5C shows a cross-section of an alternative embodiment of a piece of crockery with a first and a second part of the crockery arranged on each other;

The same or similar elements are designated in the figures with the same reference numerals.

### DETAILED EMBODIMENTS

FIG. 1 shows a flow chart of a method 100 for producing crockery filled with phase-change material, wherein the method 100 comprises the following steps of:
step 110 of pouring liquid phase-change material into a mould;
step 120 of curing of the phase-change material in the mould;
step 130 of packaging the cured phase-change material in a package;
step 140 of drawing a vacuum in the package filled with cured phase-change material;
step 150 of arranging the package filled with phase-change material against a wall of a first part of the crockery to be heated or cooled;
step 160 of arranging a second part of the crockery against the first part of the crockery, such that the package filled with phase-change material is enclosed by the first part and the second part of the crockery; and
step 170 of sealing the first and second parts of the crockery, arranged on each other, with sealing agent.

According to an exemplary embodiment of the method 100 for producing crockery filled with phase-change material, step 110 comprises of pouring liquid phase-change material into a mould. Liquid phase-change material can in particular be poured into a mould. It will however be apparent to the skilled person that use can alternatively also be made of the method of brushing, spraying, injection moulding, foaming, rotation moulding, reaction injection moulding, investment casting, and so on in order to arrange liquid phase-change material in the mould. The liquid phase-change material can comprise one or more of the following: pure phase-change material, a composition of two or more phase-change materials, a composition of phase-change material and plastic, a composition of phase-change material in a sorbent, and a composition of phase-change material in a plastic matrix.

The curing of the phase-change material in the mould can take place in different ways. According to a preferred embodiment, step 120 of the method 100 comprises of curing of the phase-change material in the mould. Depending on the intended use of the crockery, a hot or cold phase-change material is used. When crockery is for instance used in an application intended for cold foods such as ice cream dishes or for cold drinks, a cold phase-change material will be used. A cold phase-change material is typically in a liquid phase at room temperature and will cure at lower temperatures. A hot phase-change material is characterized in that the hot phase-change material tends to be in a substantially solid phase at room temperature. A hot phase-change material will pass into a liquid phase when the temperature rises. This makes such phase-change materials highly suitable for application in crockery intended for hot foods and/or hot drinks. The curing of the phase-change material can also take place in a large mould, whereby a cured bulk of phase-change material is obtained, which is then processed in a subsequent step in order to obtain small units, for instance discs, of phase-change material.

In an embodiment the step 120 of curing of the phase-change material in the mould is carried out after the phase-change material has been made liquid by means of melting, and step 120 comprises of curing of the phase-change material in the mould on a cooling plate. The cooling plate is a cooled surface which extracts heat from the liquid phase-change material in the mould. Because the cooling plate extracts heat from the phase-change material in the mould, the phase-change material will pass from a liquid phase into a solid phase, and the phase-change material will here cure.

In an embodiment the mould is a separate mould which can be placed on the cooling plate and removed from the cooling plate. The mould is preferably a mould without bottom or cover. These moulds are advantageously used for hot phase-change materials. The hot phase-change materials are poured into the mould and, after this, will cure owing to the heat exchange with the cooling plate. Because the mould has no bottom, the cured phase-change material can be removed in simple manner. It will be apparent that, depending on the intended objective of the crockery, the mould can be a round mould, a rectangular mould, a square mould, a mould with a plurality of cavities, or any other mould.

In an alternative embodiment the step 120 of curing of the phase-change material is preceded by pouring liquid phase-change material into a mould at room temperature, wherein the mould has a bottom and an upright wall. These moulds are advantageously used for cold phase-change materials. It will be apparent that the mould can also be a mould wherein one or more recesses are provided.

In an embodiment the upright wall has a minimum height of 5 mm, preferably a minimum of 10 mm and most preferably a minimum of 20 mm.

In an embodiment the mould is preferably an aluminium mould. It will be apparent that this mould can also be any one of a stainless steel, steel, metallic, metal oxidic, artificial and natural polymer mould and a mould of other natural substances (for instance glass, wood, sand, rock, and so on). The walls of the mould can comprise different material, as long as the walls keep the phase-change material enclosed.

In an embodiment the step 120 of the curing comprises of cooling the phase-change material to at least 0° C., preferably cooling to at least −12° C., most preferably to at least −19° C.

In an embodiment the step 120 of curing of the method 100 can comprise of cooling the phase-change material in a freezer or cooling by means of liquid nitrogen. It will be apparent to the skilled person that the curing of the phase-change material can also take place in, among other things, a cooling chamber, a freezer chamber, a ventilated space, chillers, and so on. It will also be apparent that cooling agents other than liquid nitrogen are possible, for instance CO2, propane, ammonia, (H)CFC, HFC, HFO, and so on.

According to an exemplary embodiment of the method 100 for producing crockery filled with phase-change material, step 130 further comprises of packaging the cured phase-change material in a package.

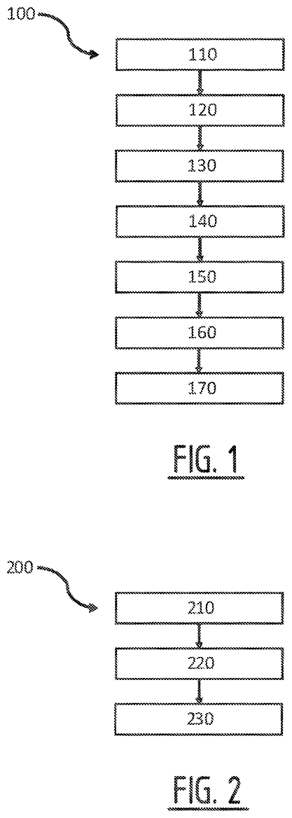

FIG. 2 shows a detailed method 200 for packaging the cured phase-change material in a package.

According to an exemplary embodiment of the method 200, step 210 comprises of placing cured phase-change material on a central part of a first film. It will be apparent to the skilled person that a plurality of cured phase-change materials can also be placed on one film, as long as there is sufficient film material to connect the first film to a second film in a subsequent step.

According to an exemplary embodiment, step 220 of method 200 comprises of placing a second film on the cured phase-change material.

Step 230 of method 200 comprises of mutually attaching the first film and the second film at corresponding peripheral parts of the two films, such that the cured phase-change material is enclosed by the package formed by the first and second film. It will be apparent to the skilled person that the first film and second film of the package can be adhered to each other in different ways at the peripheral part of the first wall, such as by means of welding, adhering, ultrasonic welding, laser welding, cold welding, and so on. The first film can for instance be welded to the second film by a heated plate with a ring, wherein the shape of the ring and the shape of the peripheral part of the first wall correspond to each other. The first film and second film can have the same thickness, but can also have mutually differing thicknesses. The first film and second film can comprise the same layers, but the first and second film can also comprise mutually differing layers. The first and second film can also comprise different zones with different properties, a film can for instance have an adhesion zone characterized by a better adhesion being obtained between two similar zones. Another zone can for instance be an aluminium film zone, through which heat will be better exchanged between the wall of the crockery to be heated or cooled and the film. Yet another zone can for instance be an insulating zone with better thermally insulating properties so as to have as little heat as possible be lost through the film which cannot be heated or cooled. The attachment of the first film to the second film is preferably air-impermeable. At least one connection point is preferably provided for drawing a vacuum in the space between the first film and the second film. A connection point can be an insert for a tube, a connection point can also be a one-way valve or device.

In an embodiment the step 220 of the method 200 is preceded by heating of the second film. It will be apparent that heating of the film can take place in different ways. The film can for instance be heated by means of hot air or by means of heated rollers over which the film runs.

According to an exemplary embodiment of the method 100 for producing crockery filled with phase-change material, step 140 comprises of drawing a vacuum in the package filled with cured phase-change material. The drawing of a vacuum can take place in different ways, for instance by arranging the package in a space with an underpressure or by arranging a vacuum pump at the connection point of the package.

According to an exemplary embodiment of the method 100 for producing crockery filled with phase-change material, step 150 comprises of arranging the package filled with phase-change material against a wall of a first part of the crockery to be heated or cooled. Arranging of the filled package can take place in different ways.

FIGS. 3A and 3B show that a package 330 filled with phase-change material is arranged against a wall 310 of a first part of the crockery to be heated or cooled. Arranging of the package filled with phase-change material against the wall of a first part of the crockery to be heated or cooled can preferably comprise of fixedly adhering 320 the package filled with phase-change material against the wall of a first part of the crockery to be heated or cooled. The adhering can preferably take place with heat-resistant adhesive 320.

FIG. 3A shows in an embodiment a cross-section of a piece of crockery wherein the adhering comprises of fixedly adhering at least a central part of the package to at least a central part of the wall to be heated or cooled. FIG. 3B shows in a top view that at least a central part of package 330 is adhered 320 to the wall 310 to be heated or cooled. It will be apparent to the skilled person that the package can also be adhered wholly to the wall to be heated or cooled.

In a preferred embodiment, shown in FIGS. 3A and 3B, it is possible for at least an edge part of the package not to be fixedly adhered to the wall to be heated or cooled. The package filled with phase-change material preferably covers at least 70% of the surface area of the wall to be heated or cooled, more preferably at least 80%, most preferably at least 90%.

FIGS. 3A and 3B show simple schematic embodiments of a piece of crockery for illustrative purposes. It will be apparent to the skilled person that the part 310 to be heated or cooled, to which the package filled with phase-change material will be adhered, can have different shapes depending on the intended objective. A soup bowl will for instance have a more concave and deeper cavity in the part to be heated. In the case of a coffee cup, a part 310 to be heated will in turn for instance take on the shape of a typical coffee cup, this typically being a deep cavity with substantially upright walls. Although FIGS. 3A and 3B show only a simplified schematic view of a piece of crockery, it will be apparent to the skilled person that the embodiments of production methods described here also apply to the production of all manner of double-walled assemblies of chinaware, glass, earthenware, plastic, lacquered plastic, plastic decorated with film, steel, lacquered steel, and so on.

In an embodiment of method 100 the step 150 is preceded by deforming the package filled with phase-change material by means of at least one formed pressure plate.

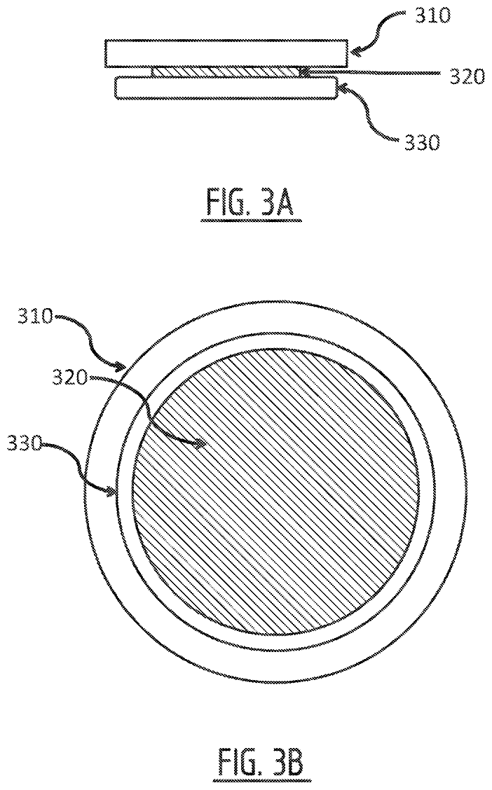

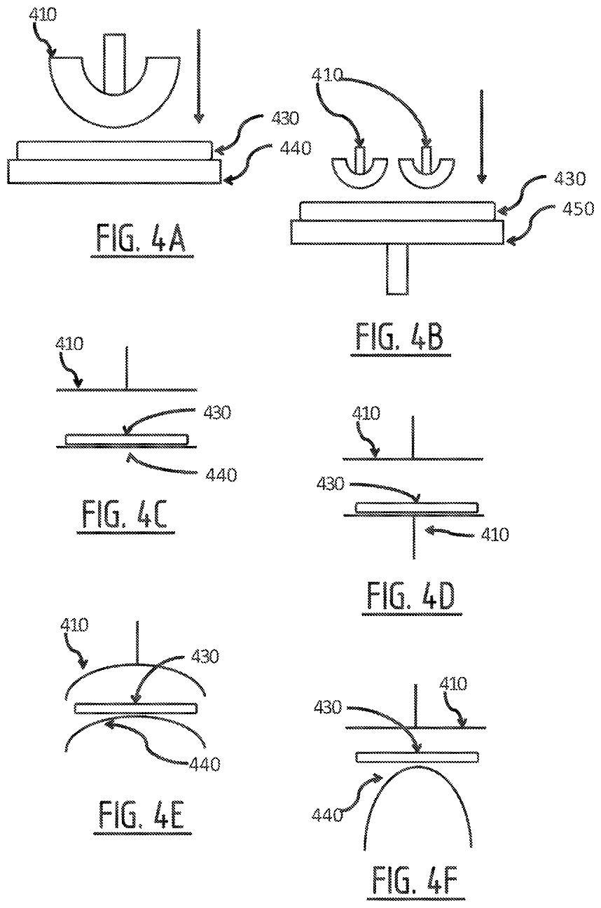

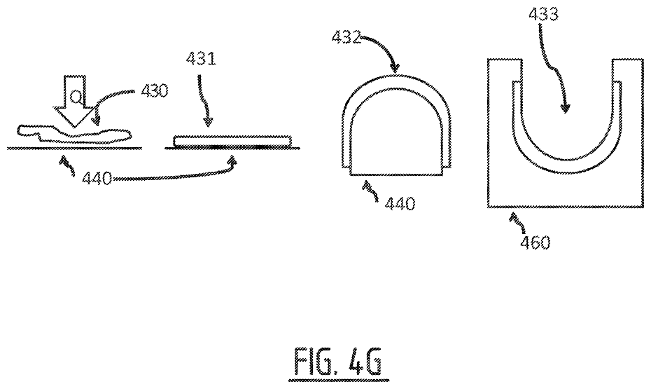

FIG. 4A shows a package 430 which is filled with phase-change material and is deformed by a formed pressure plate 410 against a base 440. In the embodiment of FIG. 4A the package filled with phase-change material is deformed by means of at least one formed pressure plate 410. It will be apparent to the skilled person that, depending on the intended objective of the type of crockery, the mould can have any shape. The mould can for instance have the shape of oven dishes, cups, dessert plates, soup bowls, dessert coupes, pizza plates, spoons and so on.

As shown in FIG. 4B, deforming of the package filled with phase-change material can also take place between two formed pressure plates 410, 450. It will be apparent that it is also possible to use a plurality of formed pressure plates 410 for the purpose of deforming the package. These shaped packages filled with phase-change material can for instance be used in serving dishes, wherein the wall to be heated or cooled comprises a plurality of tub-shaped parts.

FIGS. 4C-F show different embodiments wherein the package filled with phase-change material is deformed by formed pressure plates. FIGS. 4C and 4E show an alternatively formed pressure plate. The pressure plate can for instance be a flat pressure plate or a concave pressure plate. A concave pressure plate can for instance be used for soup bowls. It is possible for the base on which the package rests to be formed. FIG. 4D shows that the package can be shaped by a plurality of formed pressure plates. In this case the formed pressure plates are flat. It will however be apparent that these pressure plates can also be concave pressure plates. FIG. 4F shows an embodiment wherein both the base and the pressure plate have different shapes.

FIG. 4G shows an embodiment of a method wherein the package 430 filled with phase-change material is processed so that the phase-change material passes into a liquid phase 431. FIG. 4G shows that package 430 can be heated Q, whereby the phase-change material passes into liquid phase. This package 432 filled with liquid phase-change material can then be placed on a formed base 440 and will take on the shape of the formed base in a manner similar to thermoforming. A package filled with phase-change material, intended for use in a coffee cup, can for instance be heated so that the phase-change material passes into liquid phase, and then cure on a part of coffee cup 440 to be heated. Package 432 will then take on the shape of the part of the coffee cup to be heated. After the package filled with phase-change material has cured, it can then be arranged in the intended crockery 460. It will be apparent to the skilled person that a base can be an inverse mould. The base can also be a part of a piece of crockery to be heated or cooled, for instance a part of an ice cream scoop to be cooled or a part of a spaghetti plate to be heated. In FIG. 4G the base 440 can for instance be a coffee cup or any other type of crockery.

According to an exemplary embodiment of the method 100 for producing crockery filled with phase-change material, step 160 comprises of arranging a second part of the crockery against the first part of the crockery, such that the package filled with phase-change material is enclosed by the first part and the second part of the crockery.

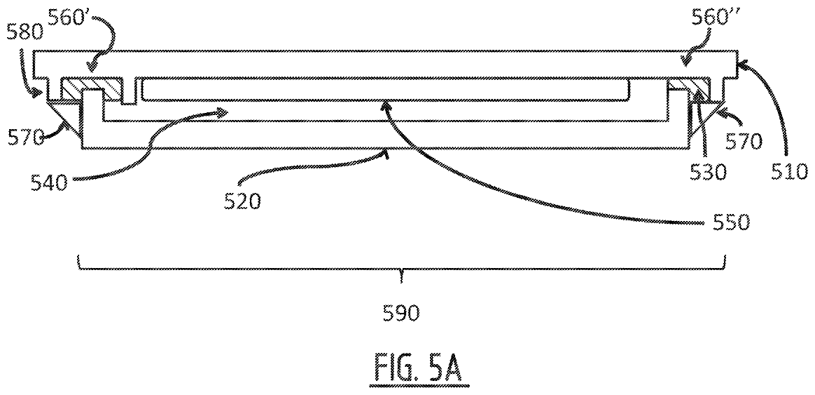

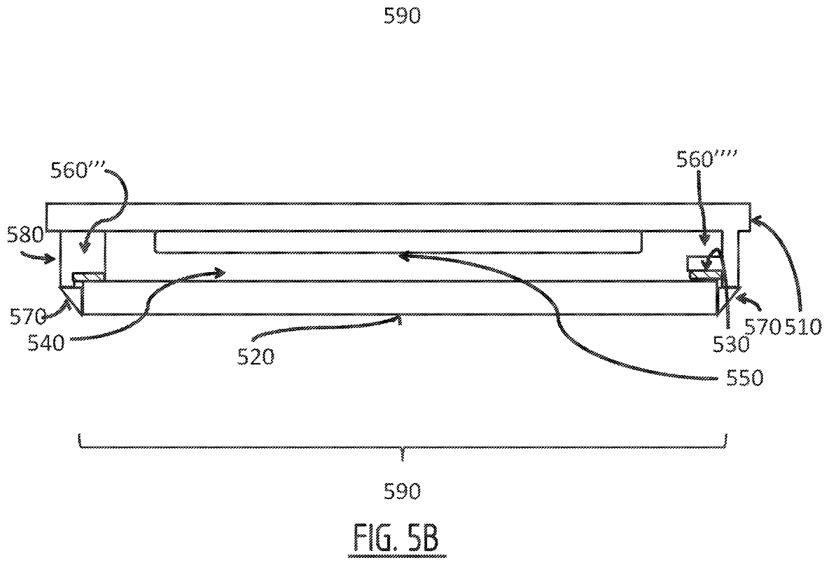

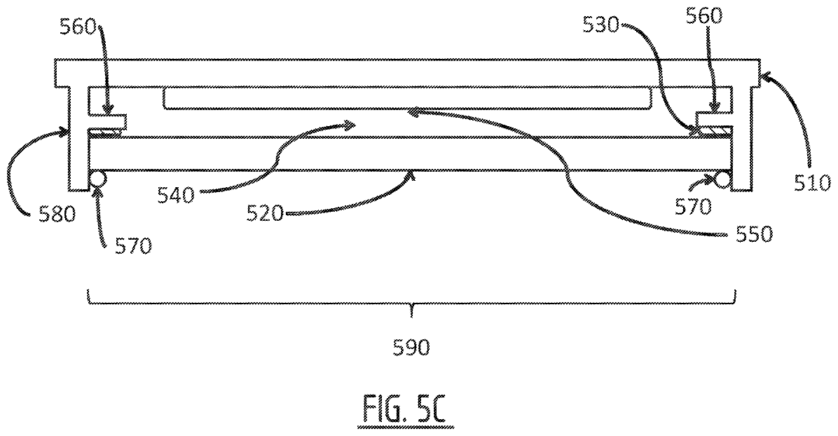

FIGS. 5A and 5B show different embodiments wherein a second part 520 of the crockery is arranged against the first part 510 of the crockery. By arranging the first part against the second part of the crockery in such a manner the package 550 filled with phase-change material becomes enclosed by the first part and the second part of the crockery. The second part is arranged against first part 510 at a recess 560. In FIGS. 5A and 5B different embodiments of recess 560 are shown on one part of the crockery. It is noted that different recesses on one part of the crockery is illustrative, and that it will be apparent that crockery will have one determined recess 560, as shown in the exemplary embodiment of FIG. 5C. When the first part is arranged on the second part, adhesive 530 can be applied at the recess 560. It will be apparent that a first part can also be arranged on the second part and that the adhesive has to be applied to the first or the second part subject to the method. Adhesive can for instance also be applied to the second part. It will be apparent that a space 540 will be created by arranging the first part against the second part. In an embodiment this space can comprise an air layer. Air is a good thermal insulator and will reduce the heat transfer between the package filled with phase-change material and a wall of the crockery not to be heated or cooled. It will be apparent that, in an alternative embodiment, this space can also be filled with different thermal insulators.

Enclosing of the package filled with phase-change material further also has the advantage that the first and the second part can be sealed rapidly in advantageous manner. This prevents microbubbles through which phase-change material can leak, whereby propagation of bacteria and microorganisms is prevented. It will be apparent to the skilled person that the first and second part of the piece of crockery can have mutually differing thicknesses.

FIGS. 5A and 5B show that a first part 510 of the crockery is sealed by means of sealing agent 570 when second part 520 has been arranged.

In an exemplary embodiment, shown in FIGS. 5A and 5B, second part 520 is positioned in a recess 560 in first part 510 provided for this purpose, and second part 520 is fixedly adhered at an edge of the first part. After first part 510 has been arranged on second part 520, space 540 can be sealed by means of arranging a sealing agent 570. FIG. 5A shows that sealing agent 570 is partially in contact with the first part 510 and is partially in contact with the second part 520, as well as with the adhesive 530. In the alternative embodiment shown in FIG. 5B sealing agent 570 has substantially no contact with adhesive 530.

FIG. 5C shows an alternative embodiment wherein a wall 580 of first part 510 of the crockery extends beyond second part 520. The first part provides hereby partially a recess in which the second part 520 can be positioned. It will be apparent that second part 520 fits closely to wall 580 in recess 590. The clearance between second part 520 and an inner side of wall 580 is preferably a maximum of 5 mm, more preferably a maximum of 3 mm, most preferably a maximum of 1 mm. It will be apparent that, depending on the intended objective of the crockery, the clearance can also be greater than 5 mm By providing a narrow clearance between wall 580 and the second part, the second part is aligned in efficient manner and seal 570 is arranged quickly in advantageous and uniform manner. This prevents microbubbles through which phase-change material can leak, whereby propagation of bacteria and microorganisms is prevented.

In an embodiment, illustrated in FIGS. 5A and 5B, fixedly adhering of second part 510 at the edge thereof to an edge part of recess 560 can comprise of applying adhesive 530 to the edge part of recess 560 and pressing second part 520 thereagainst. It is advantageous, though not critical, for the adhesion of the adhesive to roughen the surface of recess 560 before applying adhesive. Roughening the surface results in an increase in surface area, whereby the adhesive adheres better.

In an embodiment the sealing agent is determined on the basis of at least one of a colour, material, shape and finishing layer of the crockery. A sealing agent for white, ceramic crockery can for instance be a different sealing agent than for black, plastic crockery.

In an embodiment the sealing speed is determined in the sealing. It will be apparent that the sealing speed can be varied. Sealing at lower speed is advantageous, it reduces and/or prevents the creation of microbubbles.

In an embodiment the sealing agent comprises silicones.

In an embodiment the sealing agent comprises a silicone-carbon mixture. It has been found that the formation of microbubbles is reduced and/or prevented by the use of black or coloured silicone.

According to an embodiment of the method 100 for producing crockery filled with phase-change material, the step 170 of sealing the first and second parts of the crockery, arranged on each other, with sealing agent further comprises of curing of the adhesive and/or sealing agent used.

In an embodiment the adhesive and/or sealing agent used is cured by means of UV radiation.

In an embodiment the adhesive and/or sealing agent used is cured by means of heating. Heating can take place in different ways, such as by means of an oven, infrared radiation, and so on. It will be apparent to the skilled person that the curing of the adhesive and/or sealing agent used can also take place by means of a combination of UV and heating.

The skilled person will appreciate on the basis of the above description that the invention can be embodied in different ways and on the basis of different principles. The invention is not limited here to the above described embodiments. The above described embodiments and the figures are purely illustrative and serve only to increase understanding of the invention. The invention is not therefore limited to the embodiments described herein, but is defined in the claims.

1.-29. (canceled)

30. Method for producing crockery filled with phase-change material, comprising the steps of:
pouring liquid phase-change material into a mould;
curing of the phase-change material in the mould;
packaging the cured phase-change material in a package;
drawing a vacuum in the package filled with cured phase-change material;
arranging the package filled with phase-change material against a wall of a first part of the crockery to be heated or cooled;
arranging a second part of the crockery against the first part of the crockery, such that the package filled with phase-change material is enclosed by the first part and the second part of the crockery; and
sealing the first and second parts of the crockery, arranged on each other, with sealing agent.

31. Method according to claim 30, comprising of making the phase-change material liquid by means of melting, and wherein curing of the phase-change material in the mould comprises of curing of the phase-change material on a cooling plate.

32. Method according to claim 31, wherein the mould is a separate mould which can be placed on the cooling plate and removed from the cooling plate.

33. Method according to claim 30, wherein the phase-change material is liquid at room temperature, the mould has a bottom and an upright side wall, and the curing of the phase-change material in the mould comprises of cooling of the phase-change material.

34. Method according to claim 33, wherein the height of the upright side wall is a minimum of 5 mm.

35. Method according to claim 33, wherein the mould is an aluminium mould.

36. Method according to claim 33, wherein the cooling of the phase-change material comprises of cooling to at least 0° C.

37. Method according to claim 33, wherein the cooling of the phase-change material comprises of cooling in a freezer or cooling by means of liquid nitrogen.

38. Method according to claim 30, wherein the method comprises before the step of curing of the phase-change material in the mould at least one of the following steps of:
adding an antioxidant to the liquid phase-change material;
adding a gelling agent to the liquid phase-change material;
adding a thickening agent to the liquid phase-change material; and
adding a phase-change material with a higher melting point in liquid state to the liquid phase-change material.

39. Method according to claim 30, wherein the method comprises before the step of curing of the phase-change material in the mould at least one of the following steps of:
absorbing the liquid phase-change material in an organic sorbent;
absorbing the liquid phase-change material in an inorganic sorbent; and
absorbing the liquid phase-change material in a plastic matrix.

40. Method according to claim 30, wherein the packaging of the cured phase-change material in a package comprises of:
placing cured phase-change material on a central part of a first film;
placing a second film on the cured phase-change material; and
mutually attaching the first film and the second film at corresponding peripheral parts of the two films, such that the cured phase-change material is enclosed by the package formed by the first and second film.

41. Method according to claim 40, further comprising of heating the second film before placing the second film on the cured phase-change material.

42. Method according to claim 30, further comprising of deforming the package filled with phase-change material by means of at least one formed pressure plate.

43. Method according to claim 42, wherein the package filled with phase-change material is deformed between two formed pressure plates.

44. Method according to claim 42, wherein the at least one formed pressure plate corresponds to the wall of the first part of the crockery to be heated or cooled against which the package filled with phase-change material is to be arranged.

45. Method according to claim 30, wherein the arranging of the package filled with phase-change material against the wall of a first part of the crockery to be heated or cooled comprises of fixedly adhering the package filled with phase-change material against the wall of a first part of the crockery to be heated or cooled.

46. Method according to claim 45, wherein the adhering comprises of fixedly adhering at least a central part of the package to at least a central part of the wall to be heated or cooled; and/or wherein at least an edge part of the packaging is not fixedly adhered to the wall to be heated or cooled.

47. Method according to claim 30, wherein the arranging of the second part comprises of positioning the second part in a recess provided for this purpose in the first part, and of fixedly adhering the second part at an edge thereof to an edge part of the recess; and/or wherein the adhering of the second part at the edge thereof to an edge part of the recess comprises of applying adhesive to the edge part of the recess and pressing the second part thereagainst.

48. Method according to claim 30, wherein the sealing comprises of determining the sealing agent on the basis of at least one of colour, material, shape and a finishing layer of the crockery; and/or wherein the sealing comprises of determining a sealing speed.

49. Method according to claim 30, further comprising of curing of the adhesive and/or sealing agent used; and/or wherein the curing of the adhesive and/or sealing agent used is performed by means of UV radiation.
